(19) United States
(12) Patent Application Publication
(10) Pub. No.: US 2010/0327733 A1
(43) Pub. Date: Dec. 30, 2010

(54) MULTIPLE LAYER PHOSPHOR BEARING FILM

(75) Inventor: ALEXANDER SHAIKEVITCH, Livermore, CA (US)

Correspondence Address: Arent Fox LLP, 555 West Fifth Street, 48th Floor, Los Angeles, CA, 90013, US

(73) Assignee: Bridgelux, Inc., Livermore, CA (US)

(21) Appl. No.: 12/844,679

(22) Filed: Jul. 27, 2010

Related U.S. Application Data
(63) Continuation-in-part of application No. 12/492,135, filed on Jun. 25, 2009.

(51) Int. Cl. H01J 1/62; C09J 7/02; B32B 7/02; B32B 33/00; H01J 9/22

(52) U.S. Cl. 313/501; 428/354; 428/343; 428/212; 428/41.8; 156/67

(57) ABSTRACT

A multiple layer phosphor bearing film having a phosphor bearing layer comprising phosphor, a transparent protective layer, and an adhesive configured to adhere the film to a light source.

### CROSS-REFERENCE TO RELATED APPLICATION(S)

This is a Continuation-in-Part Application which claims the benefit of pending U.S. patent application Ser. No. 12/492,135, filed on Jun. 25, 2009.

### BACKGROUND

1. Field

The present disclosure relates to multiple layer phosphor bearing film for solid state lighting devices.

2. Background

Solid state devices, such as light emitting diodes (LED)s, are attractive candidates for replacing conventional light sources such as incandescent and fluorescent lamps. LEDs have substantially higher light conversion efficiencies than incandescent lamps and longer lifetimes than both types of conventional light sources. In addition, some types of LEDs now have higher conversion efficiencies than fluorescent light sources and still higher conversion efficiencies have been demonstrated in the laboratory. Finally, LEDs require lower voltages than fluorescent lamps, and therefore, provide various power saving benefits.

Unfortunately, LEDs produce light in a relatively narrow spectrum. To replace conventional lighting systems, LED-based sources that produce white light are needed. One way to produce white light is to encapsulate blue or ultra-violet (UV) LEDs in a phosphor material. The phosphor material converts monochromatic light emitted from the blue or UV LEDs to broad-spectrum white light. The phosphor material is generally formed by encapsulating the LEDs with a carrier (e.g., silicone), introducing a suspension of phosphor particles into the carrier, and then curing the carrier to provide a solid layer of material in which the phosphor particles will remain suspended. Various processes for suspending phosphor particles in silicone carriers are known in the art.

Using these processes, it is difficult to achieve consistent optical properties. Often, due to the process of suspending the phosphor particles in the carrier, the uniformity of light across the LEDs is difficult to maintain. Phosphor tends to sediment while in dispenser. Sometimes tedious and lengthy degassing is required, which results in further sedimentation of phosphor constituents, and subsequently, in varied optical parameters and color characteristics. The process itself is often time consuming and costly, requiring multiple fabrication steps to complete the process. Accordingly, there is a need in the art for a simplified and improved process for applying a phosphor material to LEDs and other solid state devices.

### SUMMARY

In one aspect of the disclosure, a film includes a phosphor bearing layer comprising phosphor, a transparent protective layer on the phosphor bearing layer, and an adhesive configured to adhere the film to a light source.

In another aspect of the disclosure, a film includes a phosphor bearing layer comprising phosphor, and a transparent protective layer on the phosphor bearing layer, the transparent protective layer comprising a refractive index that is the same or lower than the refractive index of the phosphor bearing layer.

In yet another aspect of the disclosure, a light emitting device includes a light source, and a film comprising a phosphor bearing layer having phosphor, and a transparent protective layer on the a phosphor bearing layer, the film being on the light source.

In a further aspect of the disclosure, a method of manufacturing a light emitting device includes applying a film to a light source, the film comprising a transparent protective layer and a phosphor bearing layer comprising phosphor.

It is understood that other aspects of the present invention will become readily apparent to those skilled in the art from the following detailed description, wherein it is shown and described only several aspects of a multilayer phosphor bearing film by way of illustration. As will be realized, the various aspects of the multilayer phosphor bearing film presented throughout this disclosure are capable of modification in various other respects, all without departing from the spirit and scope of the present invention. Accordingly, the drawings and the detailed description are to be regarded as illustrative in nature and not as restrictive.

### BRIEF DESCRIPTION OF THE FIGURES

Various aspects of the present invention are illustrated by way of example, and not by way of limitation, in the accompanying drawings, wherein:

FIG. 1 is a conceptual cross-sectional view illustrating an example of a light source;

FIG. 2 is a conceptual cross-sectional view illustrating an example of a light source with a multilayer phosphor bearing film;

FIG. 3 is a conceptual cross-sectional view illustrating an example of a light source with a multilayer phosphor bearing film and a lens;

FIG. 4 is a conceptual cross-section view illustrating an example of a process for manufacturing a multilayer phosphor bearing film; and

FIG. 5 is a conceptual perspective view illustrating an example of a process for manufacturing a light source with a multilayer phosphor bearing film.

### DETAILED DESCRIPTION

The present invention is described more fully hereinafter with reference to the accompanying drawings, in which various aspects of the present invention are shown. This invention, however, may be embodied in many different forms and should not be construed as limited to the various aspects of the present invention presented throughout this disclosure. Rather, these aspects are provided so that this disclosure will be thorough and complete, and will fully convey the scope of the present invention to those skilled in the art.

The various aspects of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method.

Various aspects of the present invention will be described herein with reference to drawings that are schematic illustrations of idealized configurations of the present invention. As such, variations from the shapes of the illustrations as a result, for example, manufacturing techniques and/or tolerances, are to be expected. Thus, the various aspects of the present invention presented throughout this disclosure should not be construed as limited to the particular shapes of elements (e.g., regions, layers, sections, substrates, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present invention.

It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. It will be further understood that when an element is referred to as being “formed” on another element, it can be grown, deposited, etched, attached, connected, coupled, or otherwise prepared or fabricated on the other element or an intervening element.

Various elements may be shown in the drawings with a particular orientation. By way of example, the drawings may show one element on “top” of or “above” another element. Conversely, the drawings may show one element on the “bottom” of or “below” another element. It will be understood that present invention is intended to encompass different orientations of an apparatus in addition to the orientation depicted in the drawings. By way of example, if an apparatus in the drawings is turned over, elements described as “below” or “beneath” other elements would then be oriented “above” the other elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items

Various aspects of a multilayer phosphor bearing film for a solid state lighting device will now be presented. However, as those skilled in the art will readily appreciate, these aspects may be extended to other film applications without departing from the spirit and scope of the invention. The film may include a phosphor bearing layer with phosphor. The phosphor bearing layer may be adhesive to enable the film to be applied to a light source. The film may also include a transparent protective layer on the phosphor bearing layer. The phosphor bearing layer may include phosphor particles in a low or high refractive index material, such as silicone. The transparent protective layer may also have a low or high refractive index material.

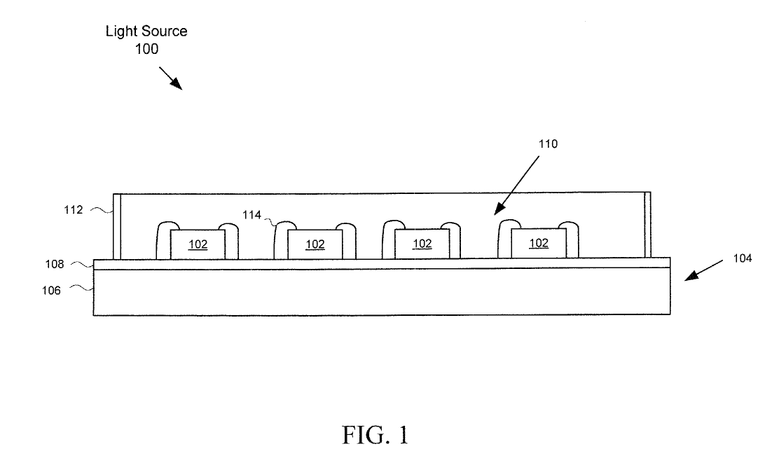

An example of a light source that is well suited for use with a multilayer phosphor bearing film will now be presented with reference to FIG. 1. However, as those skilled in the art will readily appreciate, the film may be used with other light sources, as well as other applications that could benefit from a phosphor bearing film.

Turning to FIG. 1, a light source 100 is shown with a number of light emitting cells 102 formed on a substrate 104 by means well known in the art. An LED is one example of a light emitting cell. An LED is a semiconductor material impregnated, or doped, with impurities. These impurities add “electrons” and “holes” to the semiconductor, which can move in the material relatively freely. Depending on the kind of impurity, a doped region of the semiconductor can have predominantly electrons or holes, which is referred to as n-type or a p-type semiconductor region, respectively. In an LED application, the semiconductor includes an n-type semiconductor region and a p-type semiconductor region. A reverse electric field is created at the junction between the two regions, which cause the electrons and holes to move away from the junction to form an active region. When a forward voltage sufficient to overcome the reverse electric field is applied across the p-n junction, electrons and holes are forced into the active region and combine. When electrons combine with holes, they fall to lower energy levels and release energy in the form of light. LEDs are well known in the art, and therefore, will not be discussed any further.

The substrate 104 may include a base 106 and a dielectric layer 108. The base 106 provides mechanical support for the LEDs 102 and may be made from any suitable thermally conductive material, such as, by way of example, aluminum to dissipate heat away from the LEDs 102. The dielectric layer 108 may also be thermally conductive, while at the same time providing electrical insulation between the LEDs 102 from the base 108. The LEDs 102 may be electrically coupled in parallel and/or series by bond wires 114 that extend from the LEDs to contact pads (not shown) on the dielectric layer 108. The contact pads (not shown) may be connected together by a copper circuit layer (not shown) on the dielectric layer 108 or by other means. The LEDs 102 may be encapsulated in an encapsulation material 110, such as silicone, or other transparent encapsulation material. The encapsulation material 110 may be used to focus the light emitted from the LEDs 102, as well as protect the LEDs 102 from the environment. A structural boundary 112 (e.g., a ring) may be used to support the encapsulation material 110.

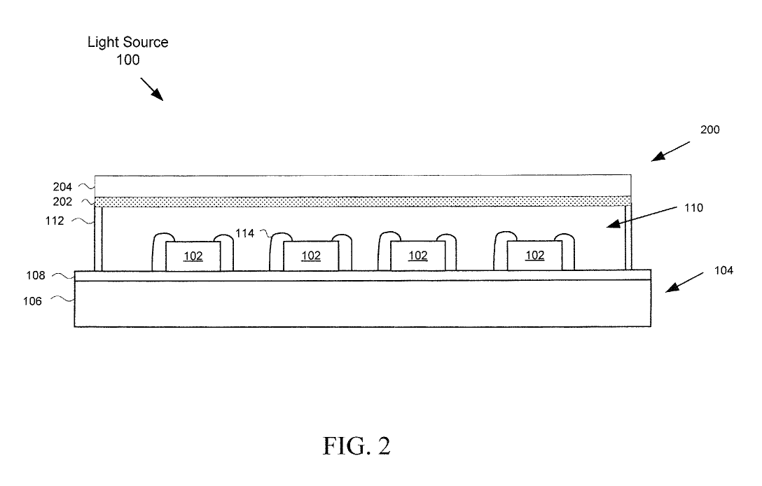

A multilayer phosphor bearing film may be applied to the light source. An example will now be presented with reference to FIG. 2. As discussed earlier, the film 200 may include a phosphor bearing layer 202 and a transparent protective layer 204. The phosphor bearing layer 202 may include phosphor particles in a high or low refractive index material, such as silicone. The transparent protective layer 204 may also have a high or low refractive index. In one embodiment of a light source 100, the phosphor bearing layer 202 has a high refractive index to provide good light extraction from the LED 102. The transparent protective layer 204 has the same or lower refractive index to provide good mechanical strength and protection. In another embodiment of the light source 100, the phosphor bearing layer 202 may have a low refractive index and the transparent protective layer 204 may have a high refractive index. The phosphor bearing layer 202 is soft and adhesive so that it may be applied directly to the encapsulation material 110. Alternatively, the phosphor bearing layer 202 may be applied directly to the LEDs 102. In this configuration, the thickness of the phosphor bearing layer 202 is preferably thicker than the LEDs 102 to fill the gaps between the LEDs 102 and uniformly cover the bond wires 114 and the entire substrate 104. The softness of the adhesive allows direct attachment to the LEDs 102 without any mechanical damage to the bond wires 114 or the LEDs 102 themselves. The diameter of the bond wires 114 can be as small as 1 mil and the speed of film application to the LEDs 102, in one manufacturing process, can vary from 0.2 to 2 mm/sec. This allows the bond wires 114 to be slowly embedded into soft adhesive and eliminates or minimizes air pockets under the bond wires 114. Due to the softness of the adhesive, the aforementioned tiny air pockets (0.1 to 1 mm cubic), if present, do not detrimentally affect the reliability of the device or decrease its performance.

Alternatively, the film 200 may include a separate adhesive layer formed with silicone or some other suitable material. The adhesive layer may be formed on the phosphor bearing layer 202 or the transparent protective layer 204.

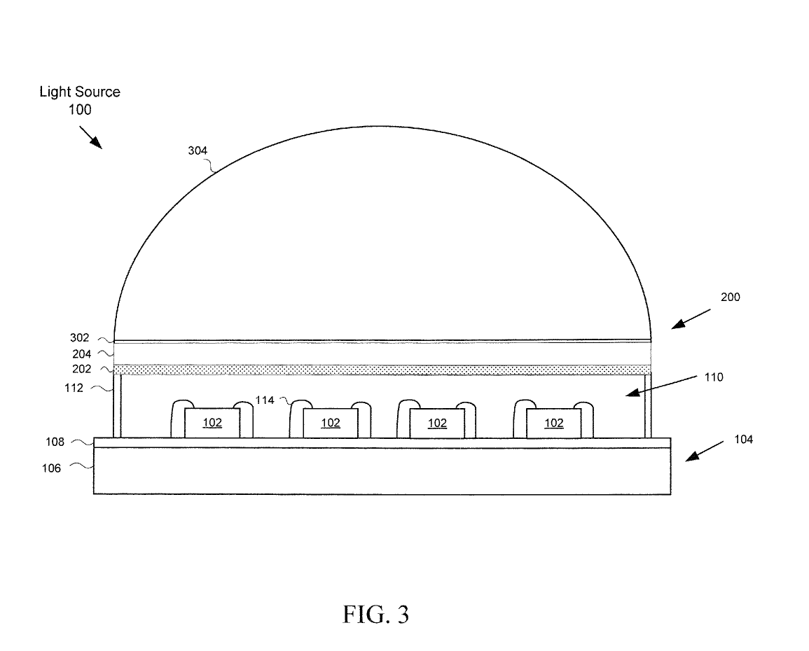

In one configuration of a multilayer phosphor film, a double sided adhesive film may be applied to a light source. An example of this configuration will now be presented with reference to FIG. 3. In this example, an adhesive layer 302 may be formed on the transparent protective layer 204 so that it may be applied directly to a lens 304. The phosphor bearing layer 202 may be soft and adhesive so that it may be applied to the encapsulation material 110 as shown in FIG. 3, or directly to the LEDs 102.

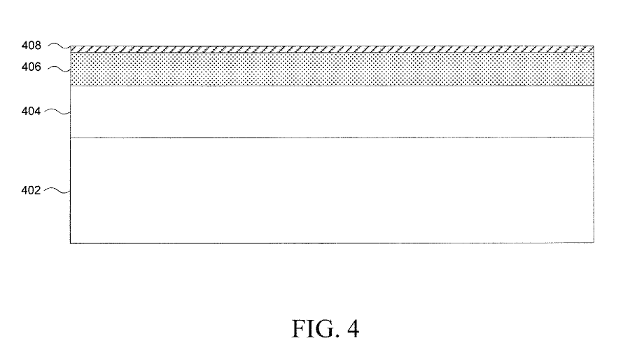

A process for manufacturing a multilayer phosphor bearing film will now be presented with reference to FIG. 4. The process begins with a substrate 402, such as glass or other suitable material. An applicator or other tool may be used to apply a silicone release coating to the substrate 402. The silicone coated substrate 402 is then cured. Once cured, a transparent protective layer 404 is formed by applying a material with the appropriate refractive index on the substrate 402 with an applicator or other suitable tool. The transparent protective layer 404 is then partially cured. Next, a phosphor bearing layer 406 is formed by mixing phosphor particles with the appropriate refractive index material to uniformly distribute the phosphor particles. The material may be a soft silicone with adhesive properties. Additives, like metal oxides, silicates or silica may be introduced to stabilize the mixture and to improve its viscoelastic properties. A thin phosphor bearing layer 406 is then applied to the partially cured transparent protective layer 404 with an applicator or other suitable tool and then cured. A removable backing material 408 may then be prepared by applying a silicone release coating to paper using an applicator or other suitable tool. The removable backing material 408 is then applied to the phosphor bearing layer 406. The substrate 402 is removed from the transparent protective layer to form the multilayer phosphor bearing film. In one configuration, an adhesive layer (not shown) may be applied to the transparent protective layer 404 to create a double sided adhesive film. In this configuration, a removable backing material (not shown) may be applied to the adhesive layer. The multilayer phosphor bearing film may be stored and/or distributed to lighting manufacturers in film sheets or film rolls.

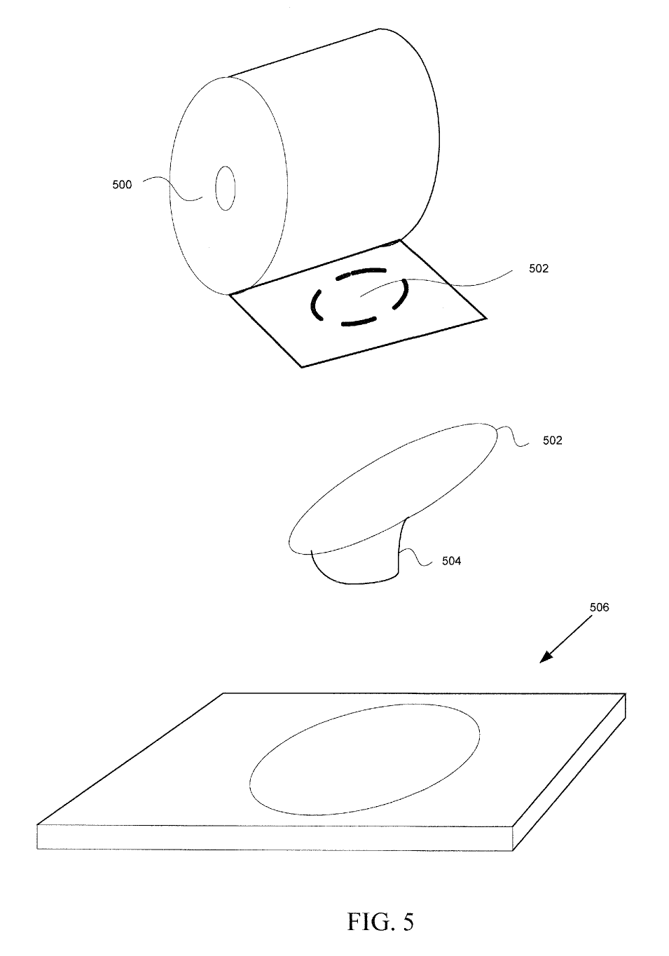

A process for manufacturing a light source with a multilayer phosphor bearing film will now be presented with reference to FIG. 5. In this example, a circular disk-shaped multilayer phosphor bearing film 502 may be cut or stamped out from a film roll 500. The backing material 504 may then be peeled from the circular disk-shaped film 502 to expose the phosphor bearing layer and then applied to the light source 506. This process may be automated using a conveyer belt manufacturing process or by some other means.

The various aspects of a multilayer phosphor bearing film are provided to enable one of ordinary skill in the art to practice the present invention. Various modifications to, and alternative configurations of the multilayer phosphor bearing films presented throughout this disclosure will be readily apparent to those skilled in the art, and the concepts disclosed herein may be extended to other lighting applications. Thus, the claims are not intended to be limited to the various aspects of this disclosure, but are to be accorded the full scope consistent with the language of the claims.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A film, comprising:
a phosphor bearing layer comprising phosphor;
a transparent protective layer on the phosphor bearing layer; and
an adhesive configured to adhere the film to a light source.

2. The film of claim 1 wherein the phosphor bearing layer comprises the adhesive.

3. The film of claim 1 wherein the adhesive comprises an adhesive layer on the phosphor bearing layer.

4. The film of claim 1 wherein the adhesive comprises an adhesive layer on the transparent protective layer.

5. The film of claim 1 wherein the transparent protective layer comprises a refractive index that is the same or lower than for the phosphor bearing layer.

6. The film of claim 1 wherein the phosphor comprises phosphor particles and the phosphor bearing layer comprises a carrier with the phosphor particles.

7. The film of claim 3 wherein the carrier comprises silicone.

8. The film of claim 1 wherein the transparent protective layer comprises silicone.

9. The film of claim 1 further comprising a removable backing material attached to the adhesive.

10. The film of claim 9 wherein the removable backing material comprises paper having a silicone release coating.

11. A film, comprising:
a phosphor bearing layer comprising phosphor; and
a transparent protective layer on the phosphor bearing layer, the transparent protective layer comprising a refractive index that is the same or lower than a refractive index for the phosphor bearing layer.

12. The film of claim 11 further comprising adhesive to adhere the film to a light source.

13. The film of claim 12 wherein the phosphor bearing layer comprises the adhesive.

14. The film of claim 12 wherein the adhesive comprises an adhesive layer on the phosphor bearing layer.

15. The film of claim 12 wherein the adhesive comprises an adhesive layer on the transparent protective layer.

16. The film of claim 12 further comprising a removable backing material attached to the adhesive layer.

17. The film of claim 16 wherein the removable backing material comprises paper having a silicone release coating.

18. The film of claim 11 wherein the phosphor comprises phosphor particles and the phosphor bearing layer comprises a carrier with the phosphor particles.

19. The film of claim 18 wherein the carrier comprises silicone.

20. The film of claim 11 wherein the transparent protective layer comprise silicone.

21. A light emitting device, comprising:
a light source; and
a film comprising a phosphor bearing layer having phosphor and a transparent protective layer on the phosphor bearing layer, the film being on the light source.

22. The light emitting device of claim 21 wherein the film further comprises adhesive to adhere the film to the light source.

23. The light emitting device of claim 22 wherein the phosphor bearing layer comprises the adhesive.

24. The light emitting device of claim 22 wherein the adhesive comprises an adhesive layer on the phosphor bearing layer.

25. The light emitting device of claim 22 wherein the adhesive comprises an adhesive layer on the transparent protective layer.

26. The light emitting device of claim 22 further comprising a lens, and wherein the film further comprises adhesive to adhere the film to the lens.

27. The light emitting device of claim 21 wherein the light source comprises one or more light emitting diodes.

28. The light emitting device of claim 27 wherein the light source further comprises an encapsulation material encapsulating the one or more light emitting diodes, the film being applied to the encapsulation material.

29. The light emitting device of claim 27 wherein the film is applied directly to the one or more light emitting diodes.

30. The light emitting device of claim 21 wherein the transparent protective layer comprises a refractive index which is the same or lower than a refractive index for the phosphor bearing layer.

31. The light emitting device of claim 21 wherein the phosphor comprises phosphor particles and the phosphor bearing layer comprises a carrier with the phosphor particles.

32. The light emitting device of claim 31 wherein the carrier comprises silicone.

33. The light emitting device of claim 21 wherein the transparent protective layer comprise silicone.

34. A method of manufacturing a light emitting device, comprising:
applying a film to a light source, the film comprising a transparent protective layer and a phosphor bearing layer comprising phosphor.

35. The method of claim 34 wherein the film is applied to the light source with adhesive.

36. The method of claim 35 wherein the phosphor bearing layer comprises the adhesive.

37. The method of claim 35 wherein the adhesive comprises an adhesive layer on the phosphor bearing layer.

38. The method of claim 35 wherein the adhesive comprises an adhesive layer on the transparent protective layer.

39. The method of claim 34 further comprising removing backing material from the film before applying the film to the light source.

40. The method of claim 34 further comprising cutting the film from a film sheet before applying the film to the light source.

41. The method of claim 34 further comprising cutting the film from a film roll before applying the film to the light source.

42. The method of claim 34 further comprising fabricating the light source with one or more light emitting diodes.

43. The method of claim 42 wherein the light source is further fabricated by encapsulating the one or more light emitting diodes with an encapsulation material.

44. The method of claim 34 wherein the light source comprises one or more LEDs, and wherein the film is applied to the light source by applying the film to the encapsulation material.

45. The method of claim 34 wherein the light source comprises one or more LEDs, and wherein the film is applied to the light source by applying the film directly to the one or more LEDs.

46. The method of claim 34 wherein the transparent protective layer comprises a refractive index which is the same or lower than a refractive index for the phosphor bearing layer.

47. The method of claim 34 wherein the phosphor comprises phosphor particles and the phosphor bearing layer comprises a carrier with the phosphor particles.

48. The method of claim 47 wherein the carrier comprises silicone.

49. The method of claim 34 wherein the transparent protective layer comprises silicone.
